(19) United States
(12) Patent Application Publication
(10) Pub. No.: US 2007/0273640 A1
(43) Pub. Date: Nov. 29, 2007

(54) ANTI-HARMFUL IMPACT INPUT DEVICE

(75) Inventors: Chun-Ching Peng, Chung Ho City (TW); Chiu-Tai Chang, Chung Ho City (TW)

Correspondence Address: PAI PATENT & TRADEMARK LAW FIRM, 1001 FOURTH AVENUE, SUITE 3200, SEATTLE, WA, 98154, US

(73) Assignee: CHIC TECHNOLOGY CORP., Chung Ho City (TW)

(21) Appl. No.: 11/420,792

(22) Filed: May 29, 2006

(51) Int. Cl. G09G 5/00

(52) U.S. Cl. 345/156

(57) ABSTRACT

An anti-harmful impact input device has one or more than one housing space formed in its main body. Each housing space accommodates at least one gravity buffer, and an elastic buffer is intercalated between the gravity buffer and the inner wall of the housing space. The gravity buffer is made of weights, lead beads, or other massive substance, and the elastic buffer is formed of two springs, rubber, cotton, foam cotton, or thermoplastic elastomer. Each of the two ends of the gravity buffer is connected to one end of the spring, whereas the other end thereof is mated to the inner wall surface of the housing space so as to suspend the gravity buffer in the housing space with the tensile force of the spring.

### BACKGROUND OF THE INVENTION

1. Field of the Invention

The present invention relates to an anti-harmful impact input device, and more particularly, to an input device which is able to protect the user's wrist from being stricken by the impact force of the input device when changing the moving direction so as to ensure a convenient and comfortable operation.

2. Description of the Prior Art

In operating an input device, the user has to constantly twist his/her wrist so as to change the moving direction of the input device from point to point.

According to the principle of the applied mechanics, when moving the input device here and there, the user must apply a force to the input device to move with varying speed and acceleration according to the applied force and time. The variation of speed and acceleration will be very large when the input device is abruptly stopped at a position. This force to halt the motion of the input device is supplied by the user in the reverse direction of the moving input device to counteract its inertia force. At this moment the user's wrist is attacked by a large impact force. If the input device is immediately turned around to move in the reversed direction, the user's wrist has to withstand even larger impact. The repeated impact force imposed on the user's wrist will accumulate and cause fatigue which can not be recovered in a short time, and at last, a permanent physical injury might result.

It is the reason why the inventor of the present invention has endeavored with great efforts for years trying to palliate the defects noticeable on the conventional input device, and finally come up with a novel anti-harmful impact input device as provided in this invention.

### SUMMARY OF THE INVENTION

It is an object of the present invention to provide an anti-harmful impact input device which can decrease its moving inertia force so as to minimize the counter force required for the user to halt the motion of the input device at a desired poison thereby making the possible harmful impact force imposed on the user's wrist as small as possible.

In view of the fact that the aforesaid harmful impact force will be greater for a heavier input device, and the required force to halt the input device which is moving with a fast speed and acceleration is considerably large, and even larger to abruptly change the moving direction immediately without pausing. Accordingly, in the present invention, an extra gravity buffer is added to absorb the energy of the inertia force of the moving input device so as to reduce the force required to halt the moving input device or even change its moving direction, thereby alleviating the harmful impact force imposed on the user's wrist at the instance when the input device stops or abruptly changes its moving direction.

### BRIEF DESCRIPTION OF THE DRAWINGS

The drawings disclose illustrative embodiments of the present invention which serve to exemplify the various advantages and objects hereof, and are as follows:

FIG. 1 is a perspective view of the present invention; and

FIG. 2 to FIG. 7 are the perspective views of the present invention from a first to a seventh embodiment respectively.

### DETAILED DESCRIPTION OF THE PREFERRED EMBODIMENT

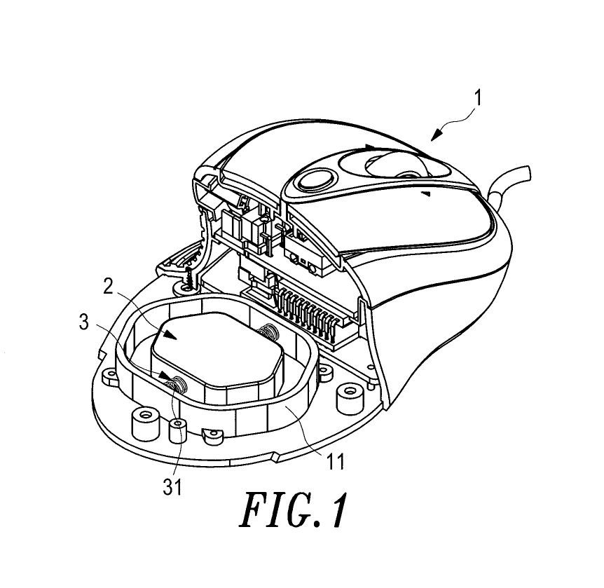

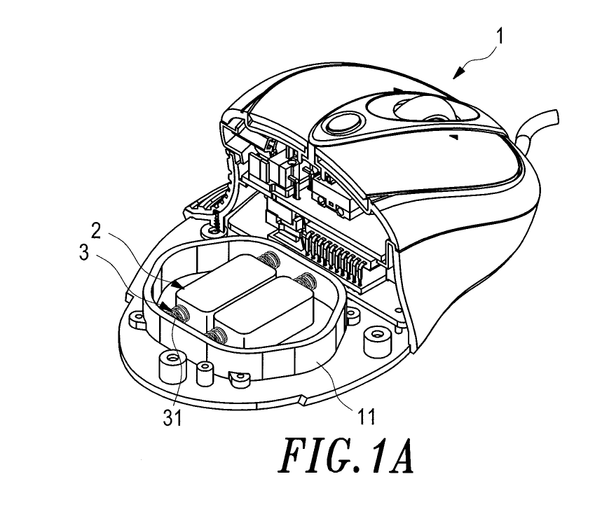

Referring to FIG. 1 and FIG. 1A, the anti-harmful impact input device of the present invention has one or more than one housing space 11 formed in its main body 1. Each housing space 11 accommodates one or more than one gravity buffer 2 made of weights, lead beads, or other massive substance. An elastic buffer 3 formed of a pair of springs 31 is intercalated between the gravity buffer 2 and the inner wall of the housing space 11. The springs 31 can be, for example, a spring of compression, extension, helical, stack, plate, ring, coiled or disk type. Each of the two elements of the springs 31 is connected to one of the two ends of the gravity buffer 2 with its one terminal, while the other terminal thereof is mated to the opposing inner wall surface of the housing space 11 so as to suspend the gravity buffer 2 in the housing space 11 with the tensile force of the couple spring 31.

When the user moves the input device, the gravity buffer 2 suspended in the housing space 11 by the springs 31 will not keep pace with the movement of the main body 1, but is lagging behind the main body 1 by the retarding effect, and part of energy produced by the inertia force of the moving main body 1 is absorbed by the retarding gravity buffer 2 via the springs 31. The retarding gravity buffer 2 will arrive at the destination shortly after the arrival of the main body 1, and the energy of the inertia force produced by the moving gravity buffer 2 is absorbed by the springs 31. In this manner the brake force required to stop motion of the input device is reduced and the impact to the user's wrist is alleviated.

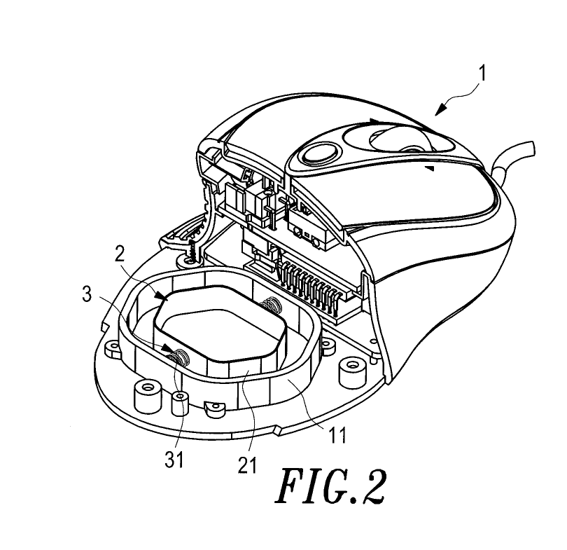

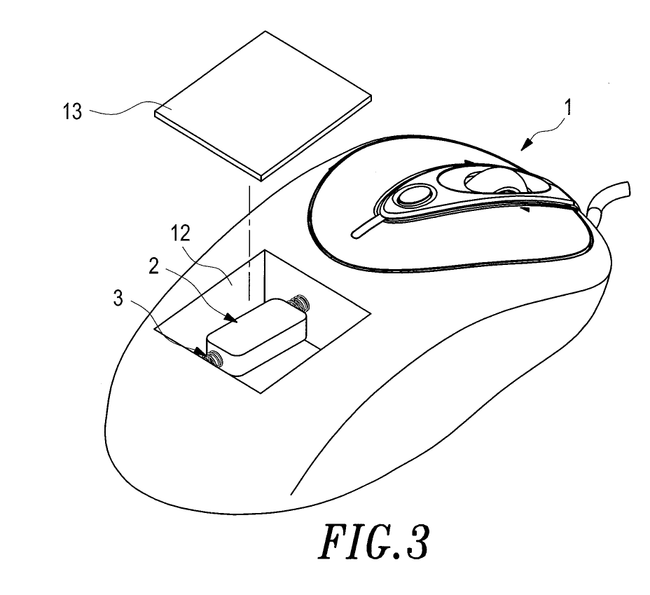

Referring to FIG. 2, the gravity buffer 2 is formed of weights, lead beads, or other massive substance accommodated in a housing 21 so as to allow its weight adjustable. Alternatively, as shown in FIG. 3, the housing space 11 can be formed into a slot 12 under the upper surface of the main body 1 with a lid 13.

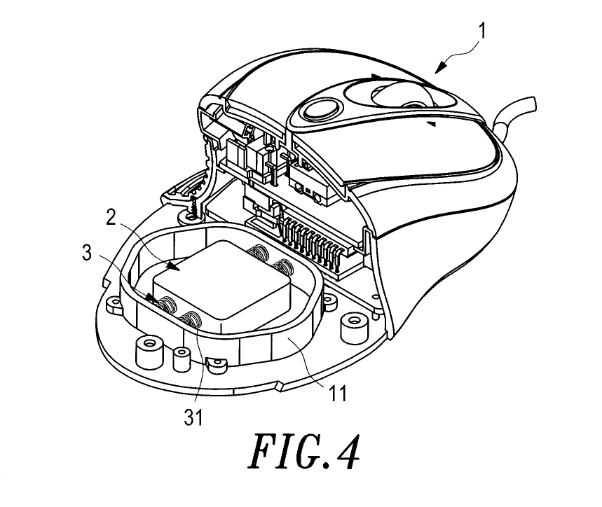

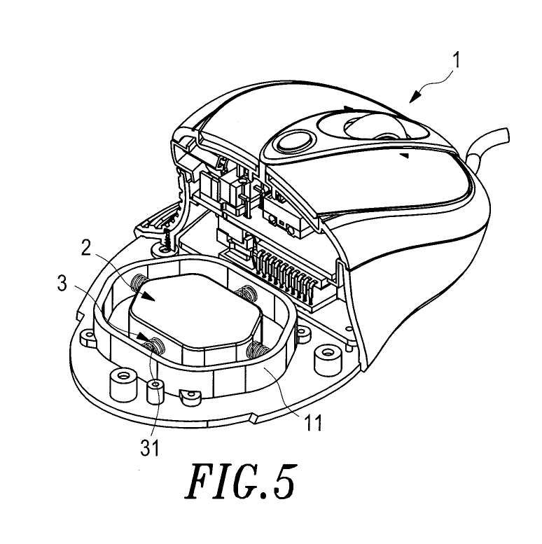

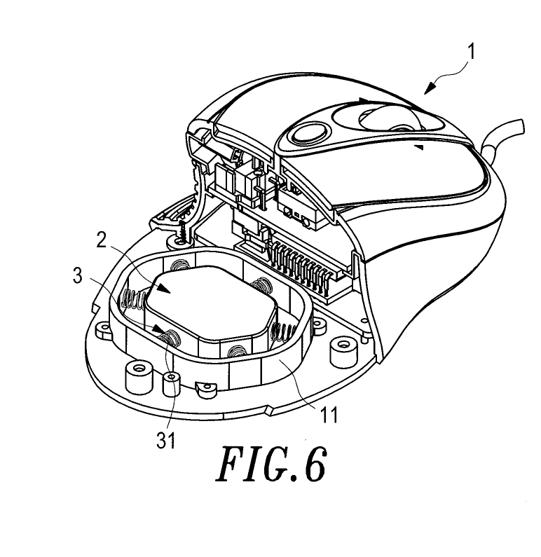

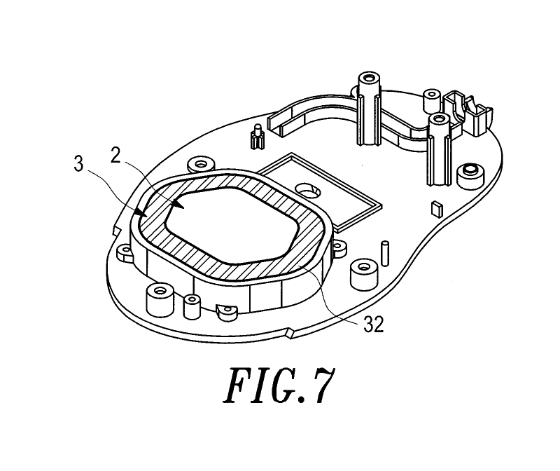

As shown in FIG. 1 through FIG. 4, one or more than one set of springs 31 may be provided to suspend the gravity buffer 2, and the longitudinal axial directions of the coupled springs 31 are in parallel, perpendicular to each other, or even intersected with an arbitrary angle to each other (see FIGS. 5 and 6) so as to allow the main body 1 of the input device to move freely in any desired direction. Besides, the elastic buffer 3 can be, for example, an elastomer formed of rubber, cotton, foam cotton, or a thermoplastic elastomer of polyamide resin, copolymerized polyamide, phenylethylene, or olefin hydrocarbons (see FIG. 7).

Although the description above contains many examples, these should not be construed as limiting the scope of the invention but as merely providing illustration of some of the presently preferred embodiments of this invention. Thus the scope of the invention should be determined by the appended clams and their legal equivalents, rather than by the examples given.

What is claimed is:

1. An anti-harmful impact input device comprising:
a main body having one or more than one housing space each accommodating one or more than one gravity buffer; and
one or more than one elastic buffer intercalated between said gravity buffer and an inner wall of said housing space.

2. The input device of claim 1, wherein said gravity buffer is made of weights, lead beads, or other heavy substance.

3. The input device of claim 1, wherein said gravity buffer is formed of weights, lead beads, or other massive substance accommodated in a housing.

4. The input device of claim 1, wherein said housing space is formed in the main body of said input device.

5. The input device of claim 1, wherein said housing space is a slot formed under an upper surface of said main body of said input device.

6. The input device of claim 1, wherein said elastic buffer is made of rubber.

7. The input device of claim 1, wherein said elastic buffer is made of cotton.

8. The input device of claim 1, wherein said elastic buffer is made of foam cotton.

9. The input device of claim 1, wherein said elastic buffer is made of a thermoplastic elastomer.

10. The input device of claim 9, wherein said thermoplastic elastomer is a polyamide resin, a copolymerized polyamide, phenylethylene, or an olefin hydrocarbon.

11. The input device of claim 1, wherein said elastic buffer are springs.

12. The input device of claim 11, wherein said spring is a compression spring, an extension spring, a helical spring, a stack spring, a plate spring, a ring spring, or a disk spring.

13. The input device of claim 11, wherein each of two ends of said gravity buffer is connected to one or more than one spring so as to suspend said gravity buffer in said housing space with said springs.

14. The input device of claim 1, wherein each end of said gravity buffer is connected to one spring so as to suspend said gravity buffer in said housing space with said springs.

15. The input device of claim 14, wherein the longitudinal axial directions of said springs are perpendicular to each other.

16. The input device of claim 14, wherein the longitudinal axial directions of said springs intersect with each other at an arbitrary angle.
